(19) United States
(12) Patent Application Publication
(10) Pub. No.: US 2005/0265046 A1
(43) Pub. Date: Dec. 1, 2005

(54) Backlight module for a liquid crystal display

(75) Inventor: Yao-Chi Liu, Panchiao City (TW)

Correspondence Address: DENNISON, SCHULTZ, DOUGHERTY & MACDONALD, 1727 KING STREET, SUITE 105, ALEXANDRIA, VA, 22314, US

(73) Assignee: AU OPTRONICS CORP.

(21) Appl. No.: 10/961,097

(22) Filed: Oct. 12, 2004

(30) Foreign Application Priority Data
May 25, 2004 (TW) 93114764

(51) Int. Cl. G02F 1/1335

(52) U.S. Cl. 362/606

(57) ABSTRACT

A backlight module for an LCD includes a light guide plate having a light incident surface and a light output surface adapted to face a display panel. A light source is provided for emitting light beams to the display panel from the light incident surface via the light output surface. And, it also includes a set of substantially identical bead-structured sheets stacked together and placed on the light output surface of the light guide plate for uniformly enhancing the light beams emitted from the light source without using any additional brightness enhancement sheet.

### BACKGROUND OF THE INVENTION

1. Field of the Invention

The present invention relates to a backlight module for a Liquid Crystal Display, more specifically to a backlight module for an LCD that uses a set of substantially identical bead-structured sheets for brightness enhancement without using additional brightness enhancement sheets.

2. Description of the Related Art

It is known that the LCD uses a backlight module for illumination. Referring to FIG. 1, a conventional backlight module 10 includes a light guide plate 11, a light source 12, a reflector plate 13 and a set of optical sheets 14.

The light source 12, preferably a cold cathode fluorescent lamp, is positioned at edgewise manner relative to the light guide plate 11. As illustrated in FIG. 1, for a single lamp design, the light guide plate 11 is usually wedge-shaped for providing uniform illumination. The light guide plate 11 is generally made from transparent acrylic resin. It has a light incident surface 112 and a light output surface 111. The light guide plate 11 is used for changing the point light source or the linear light source into the plane light source. The bottom surface of the light guide plate 11 is formed with a reflection pattern 113 for guiding the light from the light incident surface 112 towards the light output surface 111. The reflector plate 13 is positioned below the light guide plate 11 for reflecting the light beams towards the light output surface 111 to enhance illumination.

The set of optical sheets 14 is stacked together and positioned on the light output surface 111 of the light guide plate 11. The arrangement of the set of optical sheets 14 depends on application. The set of optical sheets 14 typically includes a bottom light diffusing sheet 141, a prism sheet 142, and a top light diffusing sheet 143 for products of center brightness request. The top and bottom light diffusing sheets 141, 143 cooperatively provide uniform light diffusion while the prism sheet 142 provides brightness enhancement. For high brightness request, the set of optical sheets may include a bottom diffuser, a BEF III (trade name of the 3M Company), and a DEBFD (trade name of the 3M Company) from bottom to top arranged as a set.

Prism sheets available in the commercial market include Brightness Enhancement Film (BEF, trade name of a product by the 3M Company) and Dual Brightness Enhancement Film (DBEF, trade name of a product by the 3M Company). It is noticed that the prism sheet is relatively expensive in comparison with the cost of light diffusing sheets. For example, the costs of the BEF III and the DBEF by 3M are respectively 5 times and 10 times the cost of a light diffusing sheet.

As illustrated in FIG. 2, the prism sheet 142a by 3M is made from transparent plastic, such as PMMA (polymethyl-methacrylate), and is formed with arrays of prisms 15 on the surface for recollection of light beams reflected or refracted while traveling through a light guide plate.

In addition to the high cost, another disadvantage of using a prism sheet, such as BEF III or DBEF, is that it must be used together with at least a top and a bottom light diffusing sheet for providing uniform light diffusion and avoiding scratches during handling the assembly. As a result, it is inevitable to increase additional cost.

### SUMMARY OF THE INVENTION

In view of the foregoing disadvantages of using the conventional optical sheets for brightness enhancement and light diffusion, an object of the present invention is to provide a backlight module with cost-reduced optical sheets capable of brightness enhancement and light diffusion.

According to the present invention, the backlight module includes a light guide plate having a light incident surface and a light output surface adapted to face a display panel. A light source is provided for emitting light beams to the display panel from the light incident surface via the light output surface. And, it also includes a set of substantially identical bead-structured sheets stacked together and placed on the light output surface of the light guide plate for uniformly enhancing the light beams emitted from the light source. The set of bead-structured sheets can achieve desired optical effects without having to use any additional brightness enhancement sheet.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic diagram of a backlight module showing the structure of a backlight module for a conventional Liquid Crystal Display;

FIG. 2 is a schematic diagram showing the cross-sectional view of the conventional optical sheets in which BEF III is employed;

FIG. 3 is a schematic diagram showing the cross-sectional view of a preferred embodiment of the present invention;

FIG. 4A is a schematic diagram showing another preferred embodiment of the present invention;

FIG. 4B is a schematic diagram showing still another preferred embodiment of the present invention;

FIG. 5 is a schematic diagram illustrating light transmission paths in a bead-structured sheet according to the present invention;

FIG. 6A is a plan view showing the measurement positions on the panel when conducting a brightness measurement;

FIG. 6B is a graph showing the relationship between the number of bead-structured sheets stacked together and associate brightness measured at the measurement positions as shown in FIG. 6A;

FIG. 7A is a graph showing the change of brightness at different horizontal viewing angles when using Light Guide Plate only, three bead-structured sheets, and BEFIII respectively;

FIG. 7B is a graph showing the change of brightness at different vertical viewing angles when using Light Guide Plate only, three bead-structured sheets, and BEFIII respectively and

FIG. 8 is a table showing the relationship between the number of bead-structured sheets stacked together and correspondent brightness measured at different perpendicular viewing angles.

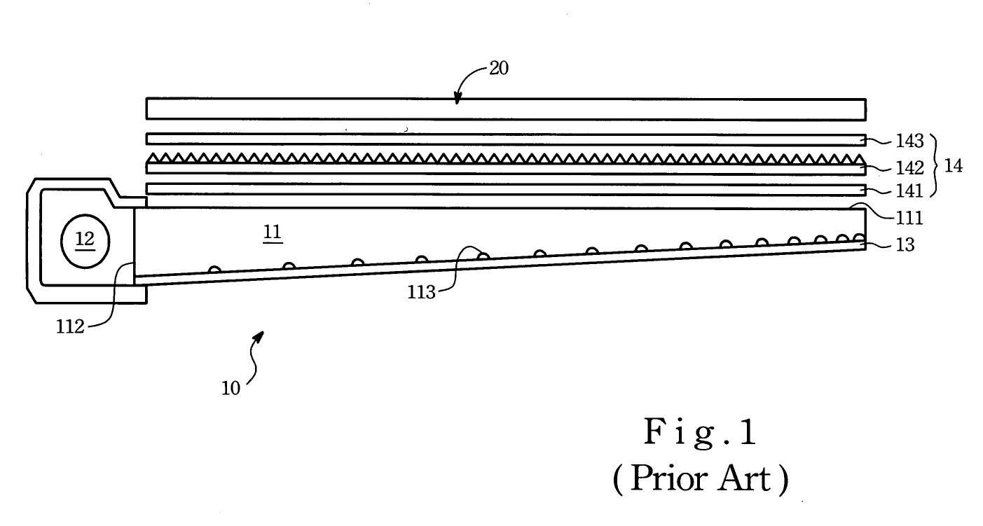

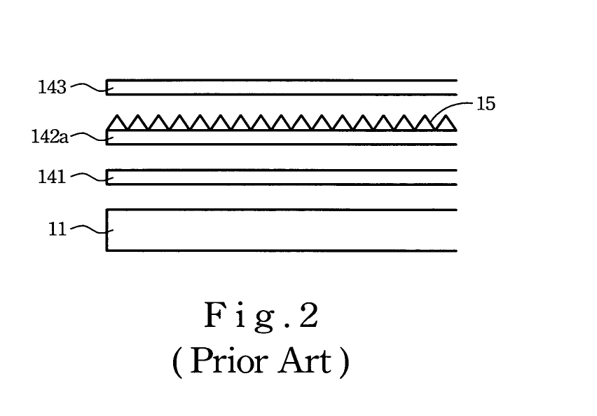

### DETAILED DESCRIPTION OF THE PREFERRED EMBODIMENTS

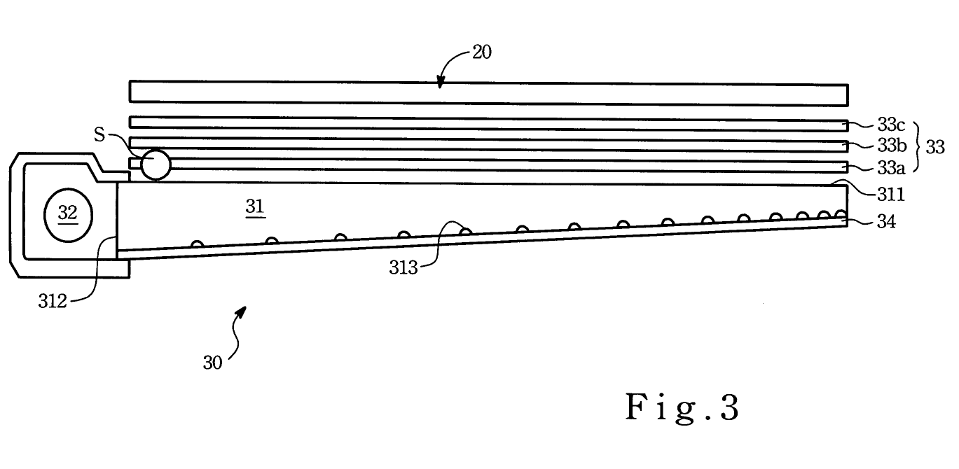

Referring to FIG. 3, the backlight module 30 includes a light guide plate 31, a light source 32, and a set of bead-structured sheets 33 according to one of the preferred embodiments of the present invention. The light source 32, preferably a cold cathode fluorescent lamp, is positioned at edgewise manner relative to the light guide plate 31 for providing side light.

The light guide plate 31, usually made from transparent acrylic resin, has a light incident surface 312 and a light output surface 311, which is positioned to face the display panel 20. The light guide plate 31 changes the linear light source 32 into the plane light source and guides the light beams towards the display panel 20.

The lower surface of the light guide plate 31 is formed with a plurality of transparent beads 313 for light diffusion. A reflector plate 34 is positioned below the light guide plate 31 for enhancing brightness by reflecting reflected or refracted light beams towards the display panel 20.

The bead-structured sheets 33 are substantially identical. They are stacked together and positioned on the light output surface 311 of the light guide plate 31. When light beams are guided to travel through the bead-structured sheets 33 towards the display panel 20, they will be more uniformly diffused but still converge enough light to achieve uniform illumination and brightness enhancement without using any conventional brightness enhancement sheets, such as prism sheets.

The set of bead-structured sheets 33 is preferably formed by stacking three substantially identical bead-structure sheets together. According to the experiment results, the luminance angle of triple bead-structured sheets is smoother than that of the conventional BEF III. As a result, light beams will be more uniformly distributed all over the display panel 20. Accordingly, the set of bead-structured sheets can comply with the safety requirement of TFT TCO'03.

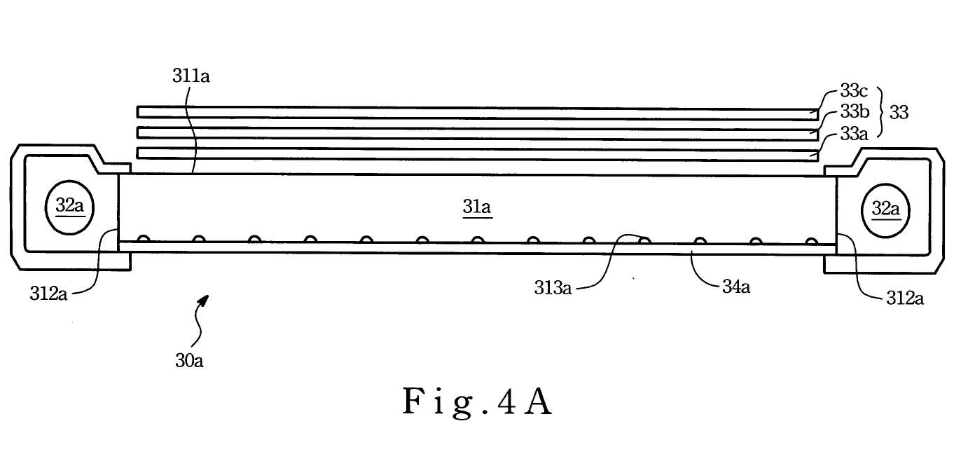

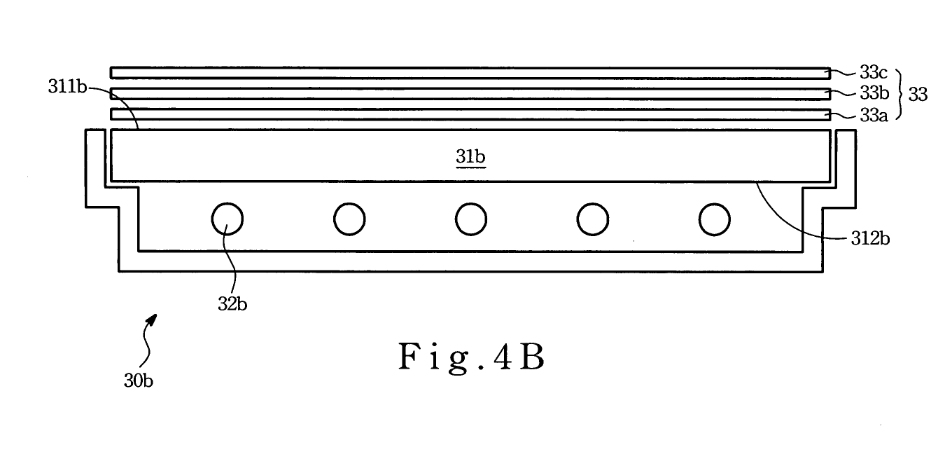

FIG. 4A shows another preferred embodiment of the backlight module of the present invention which has the structure similar to the embodiment of FIG. 3. The main difference is that the light guide plate 31a is of substantially uniform thickness. It has two light incident surfaces 312a. Two cold cathode fluorescent lamps 32a are positioned at edgewise manner respectively adjacent to the light incident surfaces 312a of the light guide plate 31a. The remaining parts are the same.

FIG. 4B shows still another preferred embodiment of the present invention. Its structure is similar to that of the first preferred embodiment of FIG. 3 except the light source. The light incident surface 312b is positioned opposite to the light output surface 311b of the light guide plate 31b due to the position of the direct light source 32b. The remaining parts are the same. The number of bead-structured sheets used depends on actual applications.

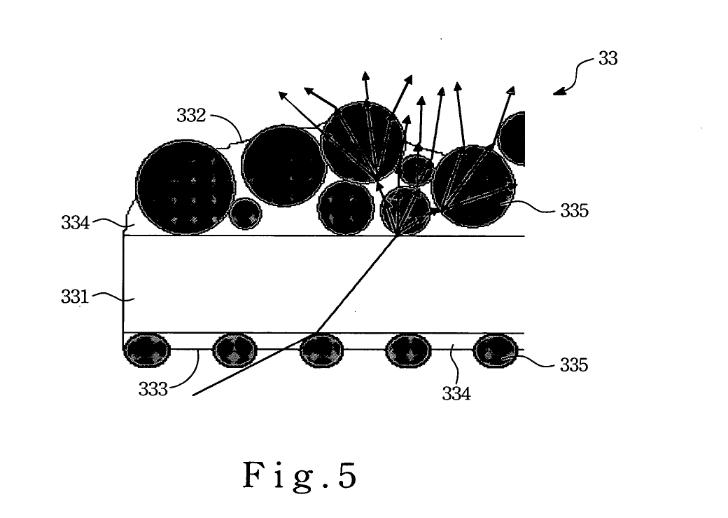

FIG. 5 illustrates an enlarged view of the encircled portion (S) of the bead-structured sheets 33 as shown in FIG. 3. Each of the bead-structured sheets 33 is formed from a transparent base sheet 331. A surface layer 332 is laminated on an upper surface of the base sheet 331, and a sticking-inhibiting layer 333 laminated on the rear surface of the base sheet 331.

The base sheet 331 is formed from a transparent and colorless synthetic resin, including PET (polyethylene terephthalate), polyethylene naphthalate, acrylic resin, polycarbonate, polystyrene, polyolefin, cellulose acetate, weather-resistant vinyl chloride and Polyester. The surface layer 332 includes a binder 334, preferably a thermosetting resin, and transparent beads 335 of different dimensions.

The transparent beads 335 are substantially spherical in shape. They can be made from transparent and colorless material, such as acrylic resin, polyurethane, polyvinyl chloride, polystyrene, polyacrylonitrile and polyamide. The size of the beads is preferably within the range of from about 0.1 μm to about 100 μm. The transparent beads 335 are scattered randomly within the binder 334 for light diffusion.

The sticking-inhibiting layer 333 is formed from a highly wear resistant binder 334 to prevent from scratch. The sticking-inhibiting layer 333 contains multiple transparent beads 335 scattered in the binder 334 to enhance sticking inhibition.

There are several bead-structured sheets available in the market for the purpose of light diffusion rather than brightness enhancement. For instance, a bottom light diffusing sheet made by Keiwa under the model name of Keiwa BS-040 is applicable to the present invention.

According to the preferred embodiment of the present invention, three bead-structured sheets as a set can provide desirable uniform brightness enhancement effect without using any additional prism sheets or any other brightness enhancement sheet. Moreover, it does not need any additional brightness enhancement sheet because the measured luminance angle of the bead-structured sheets is smoother than that of the conventional BEF III.

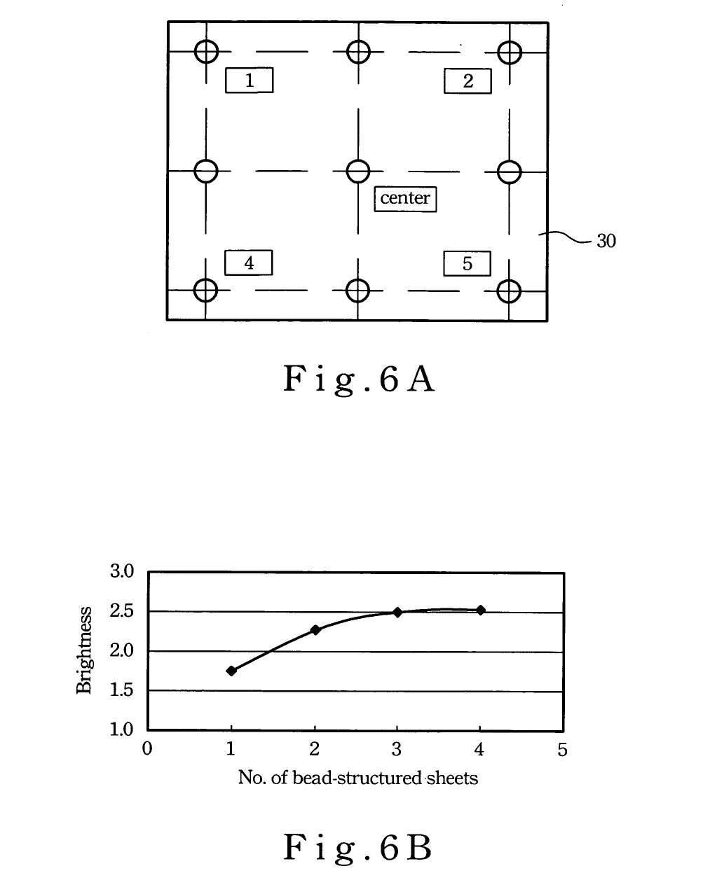

FIG. 6A illustrates the measurement spots of the backlight module 30 when conducting the brightness measurement. The measurement references and conditions are as follows: in the measurement, we use 7.5 mA cold cathode fluorescent lamp by TOA Co. as the light source, and a lamp reflector of ALSET E60V. We use three bottom light diffusing sheets of Keiwa BS-040 as a set of bead-structured sheets for brightness enhancement.

Table 1 shows the relationship between the number of bead-structured sheets used and associate brightness variation when measured at the positions as shown in FIG. 6A. It shows that the maximum brightness enhancement can be achieved when three bead-structured sheets of Keiwa BS-040 are stacked together as a set. Accordingly, for this arrangement, three sheets of Keiwa BS-040 are enough to achieve the desirable brightness.

FIG. 6B shows the relationship between the number of bead-structured sheets used in the backlight module and associate brightness variation. One can clearly observe that the brightness does not change much when the number of bead-structured sheets is increased from three to four. Based on the concern of cost, applying three pieces of bead-structured sheets stacked together as a set can be the most cost-effective solution. However, the number of bead-structured sheets actually used is based on application. Under the present experimental environment, three Keiwa BS-040 sheets as a set can meet the center brightness requirement without using any additional prism sheet or any other brightness enhancement sheet or any light diffusing sheet.

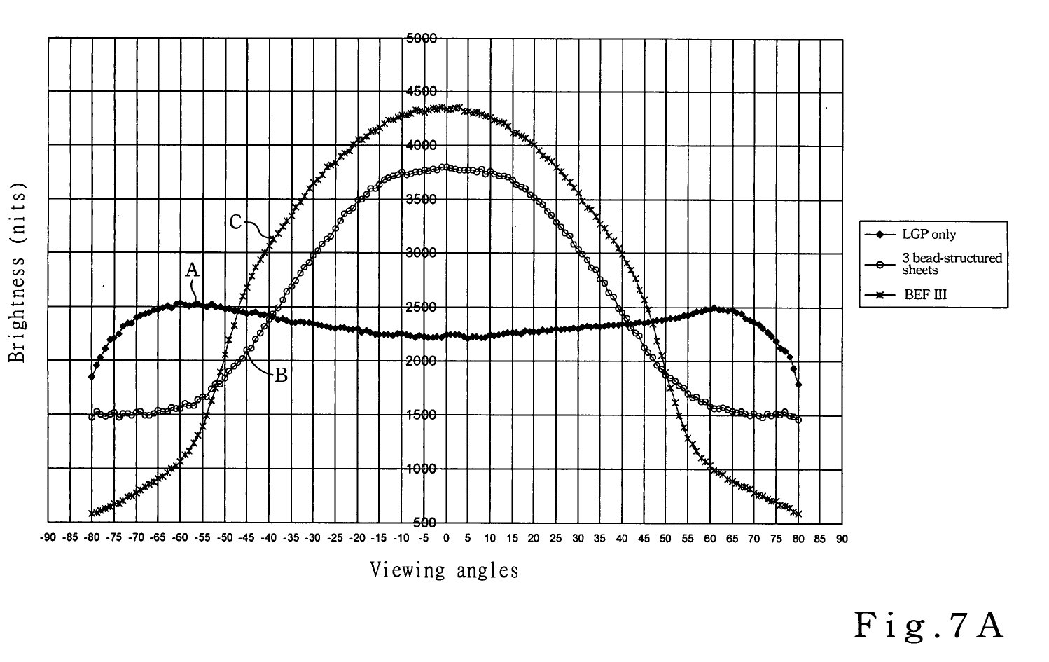

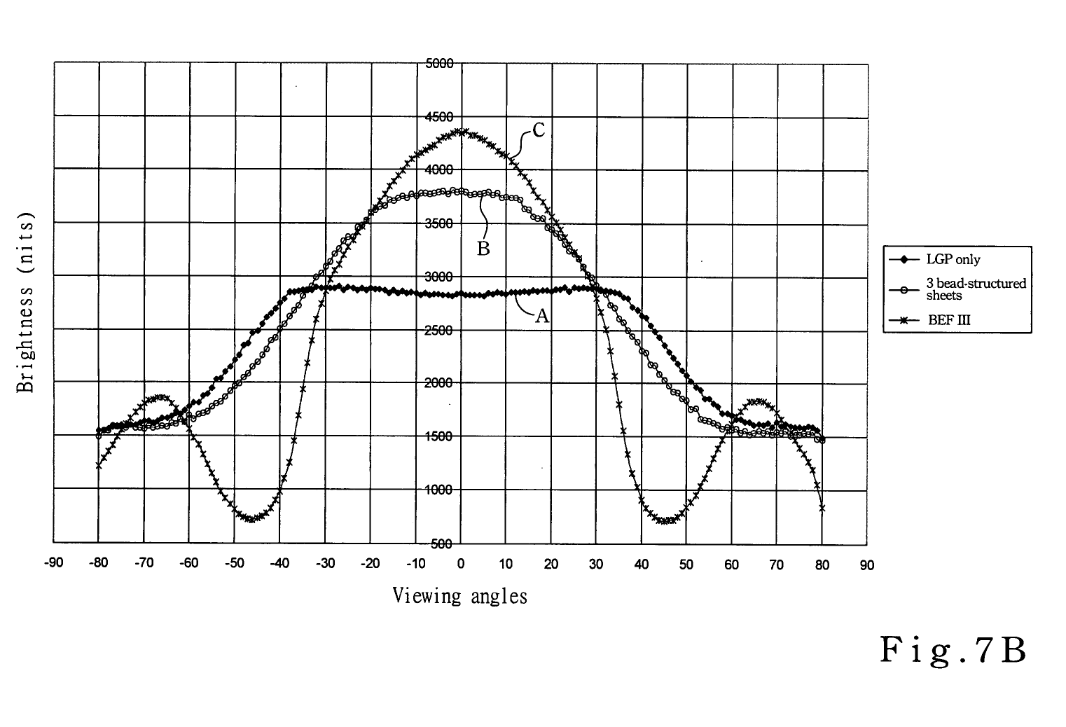

FIGS. 7A and 7B are graphs representing experiment results of brightness measured at various horizontal and vertical viewing angles with respect to the center position of the backlight module of the present invention. From the experiment results, it can be shown that the light convergence effects are almost the same for using three bead-structured sheets as a set and using conventional BEF III. However, using three-bead structured sheets as a set can achieve wider viewing angles than using conventional BEF III.

Accordingly, the present invention can easily meet the safety requirement of TFT TCO'03. More importantly, using the three bead-structured sheets as a set will not generate moire as using conventional optical sheets. And the bead-structured sheets are available in the market with a price lower than that of conventional prism sheets. Furthermore, the bead-structured sheets with a highly wear resistant binder in the sticking-inhibiting layer can also avoid scratches during handling the assembly, thereby increasing the yield rate.

As is understood by a person skilled in the art, the foregoing preferred embodiment of the present invention is an illustration of the present invention rather than limiting thereon. It is intended to cover various modifications and similar arrangements included within the spirit and scope of the appended claims, the scope of which should be accorded the broadest interpretation so as to encompass all such modifications and similar structure.

TABLE 1

| | | | | | | center |
|---|---|---|---|---|---|---|
| Brightness | 1 | 2 | center | 4 | 5 | gain |
| Light guide | 1769 | 1802 | 2099 | 1791 | 1817 | — |
| Bead-structured sheet × 1 | 3074 | 3145 | 3657 | 3155 | 3195 | 1.74 |
| Bead-structured sheet × 2 | 4069 | 4149 | 4772 | 4159 | 4189 | 2.27 |
| Bead-structured sheet × 3 | 4511 | 4581 | 5244 | 4601 | 4601 | 2.50 |
| Bead-structured sheet × 4 | 4611 | 4662 | 5295 | 4662 | 4652 | 2.52 |

(nits)

1. A backlight module for a Liquid Crystal Display comprising:
a light guide plate having a light incident surface and a light output surface adapted to face a display panel;
a set of substantially identical bead-structured sheets stacked together and placed on said light output surface of said light guide plate; and
a light source for emitting light beams to the display panel, the light beams traveling from said light incident surface through said set of substantially identical bead-structured sheets and directly to the display panel.

2. The backlight module according to claim 1, wherein said light source is positioned at an edgewise manner with respect to said light guide plate.

3. The backlight module according to claim 1, wherein said light source is positioned opposite to the light output surface of said light guide plate.

4. The backlight module according to claim 1, wherein each of said set of substantially identical bead-structured sheets is formed from a base sheet, a surface layer laminated on an upper surface of said base sheet, and a sticking-inhibiting layer laminated on a rear surface of said base sheet.

5. The backlight module according to claim 4, wherein said base sheet is formed from a transparent material selected from a group consisting of polyethylene terephthalate, polyethylene naphthalate, acrylic resin, polycarbonate, polystyrene, polyolefin, cellulose acetate, weather-resistant vinyl chloride and Polyester.

6. The backlight module according to claim 4, wherein said surface layer includes a binder and a plurality of transparent beads of different dimensions scattered randomly within said binder.

7. The backlight module according to claim 4, wherein said sticking-inhibiting layer includes a binder and a plurality of transparent beads scattered in said binder.

8. The backlight module according to claim 1, wherein said set of substantially identical bead-structured sheets includes at least two substantially identical bead-structured sheets.
